(19) United States
(12) Patent Application Publication
(10) Pub. No.: US 2026/0204904 A1
(43) Pub. Date: Jul. 16, 2026

(54) PHOTOVOLTAIC SYSTEM

(71) Applicant: LG INNOTEK CO., LTD., Seoul (KR)

(72) Inventor: Ju Young JANG, Seoul (KR)

(73) Assignee: LG INNOTEK CO., LTD., Seoul (KR)

(21) Appl. No.: 19/139,295

(22) PCT Filed: Dec. 12, 2023
(86) PCT No.: PCT/KR2023/020482

§ 371 Date: Jun. 13, 2025

(30) Foreign Application Priority Data
Dec. 13, 2022 (KR) 10-2022-0174249

(51) Int. Cl. H02J 3/001; H02J 13/12; H02J 13/13; H02J 13/183; H02J 101/24; H02J 107/00; H02J 107/105

(52) U.S. Cl. CPC H02J 3/001; H02J 13/12; H02J 13/1311; H02J 13/1321; H02J 13/183; H02J 2101/24; H02J 2107/105; H02J 2107/40

(57) ABSTRACT

A control module according to one embodiment of the present invention comprises: a switching unit for selectively connecting an output or system power source of a power conversion device to a load; and a control unit for monitoring the power conversion device, wherein the control unit controls a photovoltaic module connected to the power conversion device.

### TECHNICAL FIELD

The present invention relates to a photovoltaic system, and more specifically, to a control module for controlling a photovoltaic system, a battery module, and a photovoltaic system.

### BACKGROUND ART

Solar power generation is an eco-friendly energy generation method that replaces existing chemical power generation or nuclear power generation. Solar power generation includes a standalone type in which a battery is connected to a converter and a connection type in which it is connected to a power grid, and in general, standalone power generation consists of solar cells, storage cells, power conversion devices and the like, and power grid-connected systems are connected to commercial power so that load grid lines and power can be exchanged with each other.

In the event of a fire or other abnormality in a solar power generation panel, the voltage must be lowered below a certain level within a short period of time to protect workers from electric shock and other causes for subsequent processing. A technology that can detect abnormal voltage and safely lower the voltage is needed.

### DETAILED DESCRIPTION OF THE INVENTION

### Technical Subject The technical problem to be solved by the present invention is to provide a control module for controlling a photovoltaic system, a battery module, and a photovoltaic system.

### Technical Solution

In order to solve the above technical problem, a control module according to one embodiment of the present invention comprises: a switching unit for selectively connecting an output or system power source of a power conversion device to a load; and a control unit for monitoring the power conversion device, wherein the control unit controls a photovoltaic module connected to the power conversion device.

In addition, the control unit can control signal transmission from the power conversion device to the photovoltaic module.

In addition, the control unit can transmit a control signal to the power conversion device to block signal transmission to the photovoltaic module when a rapid shut down (RSD) situation occurs.

In addition, the control unit may include an energy management system (EMS).

In addition, the control unit communicates with the power conversion device using a first communication method, and the first communication method may be different from a second communication method which is a communication method between the power conversion device and the photovoltaic module.

In addition, a communication signal according to the first communication method can be converted into a communication signal according to the second communication method in a signal conversion unit included in the power conversion device.

In addition, the first communication method may include a CAN communication method, and the second communication method may include a PLC communication method.

In addition, the control unit can control a plurality of inverters.

In addition, the switching unit may include an automatic transfer switch (ATS).

In addition, the control unit can monitor a battery module being connected to the power conversion device.

In order to solve the above technical problem, a battery module according to one embodiment of the present invention includes a DC-DC converter that converts the output of a power conversion device; an energy storage unit that is connected to the DC-DC converter and is charged or discharged; and a control unit that monitors the power conversion device, and the control unit controls a photovoltaic module being connected to the power conversion device.

In addition, the control unit can control signal transmission from the power conversion device to the photovoltaic module.

In addition, the control unit can transmit a control signal to the power conversion device to block signal transmission to the photovoltaic module when a rapid shut down (RSD) situation occurs.

In order to solve the above technical problem, a photovoltaic system according to one embodiment of the present invention includes: a power conversion device that receives an output of a photovoltaic module and performs a first communication with the photovoltaic module; and a control module that selectively connects the output of the power conversion device or a grid power supply to a load, wherein the control module controls the photovoltaic module through a second communication with the power conversion device.

In addition, the control module may include any one of the control modules described above.

### Advantageous Effects

According to embodiments of the present invention, main control of an inverter, MLPE, battery, and the like is possible from a backup box. Even if multiple inverters, MLPEs, and batteries are connected, one backup box can be controlled. The inverter and MLPE can be monitored and RSD operation can be performed from the backup box without adding a module configured as a separate accessory for RSD operation. The backup box and the inverter communicate using the same or different communication as the communication between the inverter and MLPE, thereby increasing system compatibility.

### BRIEF DESCRIPTION OF DRAWINGS

FIG. 1 is a block diagram showing a connection relationship with other components of a control module according to an embodiment of the present invention.

FIG. 2 is a block diagram of a control module according to an embodiment of the present invention.

FIG. 3 and FIG. 4 are block diagrams of a control module according to an implementation example of the present invention.

FIG. 5 is a block diagram showing a connection relationship with other components of a battery module according to an embodiment of the present invention.

FIG. 6 is a block diagram of a battery module according to an embodiment of the present invention.

FIG. 7 is a block diagram of a photovoltaic system according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention. In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used.

These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction with respect to one component may be included

A modified embodiment according to the present embodiment may include some components of each embodiment and some components of other embodiments together. That is, the modified embodiment may include one embodiment among various embodiments, but some components may be omitted and some components of the corresponding other embodiment may be included. Or, it may be the opposite. The features, structures, effects, and the like to be described in the embodiments are included in at least one embodiment, and are not necessarily limited to only one embodiment. Furthermore, the features, structures, effects, and the like exemplified in each embodiment may be combined or modified and implemented in other embodiments by a person having ordinary knowledge in the field to which the embodiments belong. Therefore, the contents related to such combinations and modifications should be interpreted as being included in the scope of the embodiment.

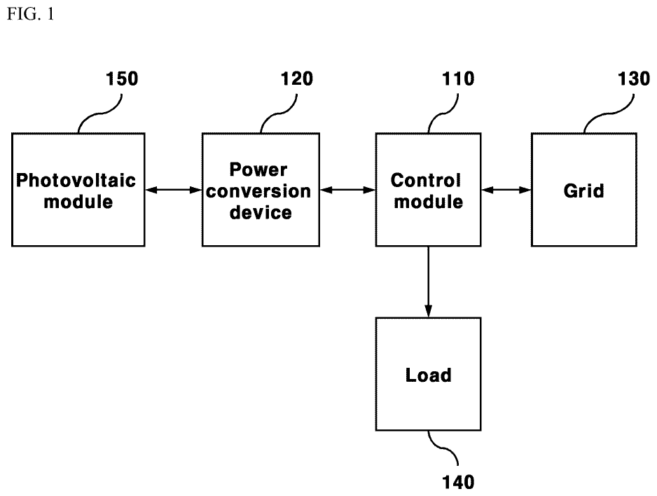

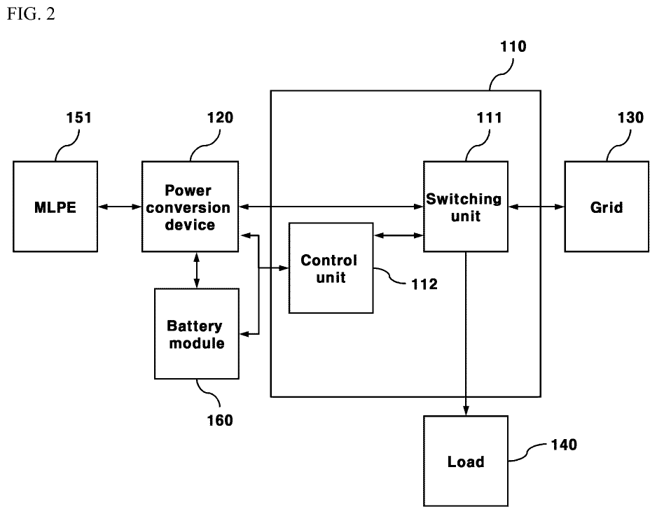

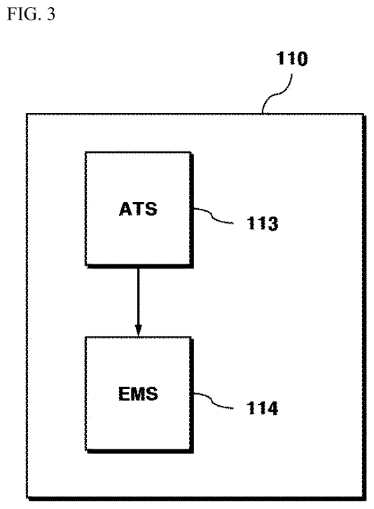

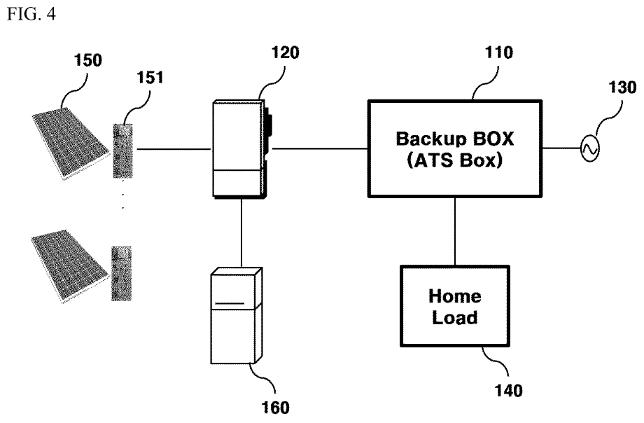

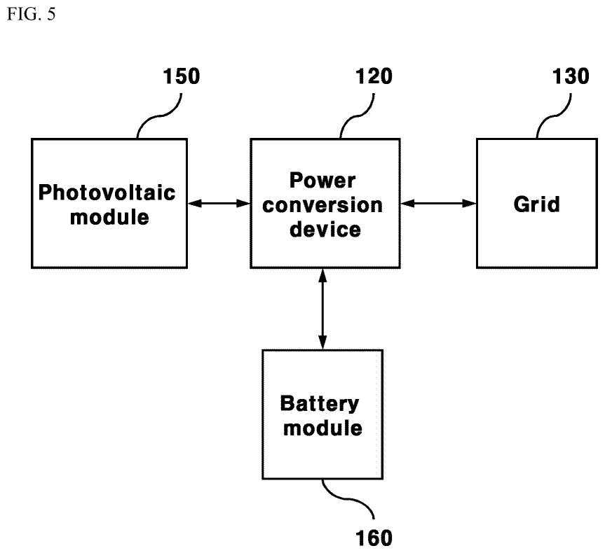

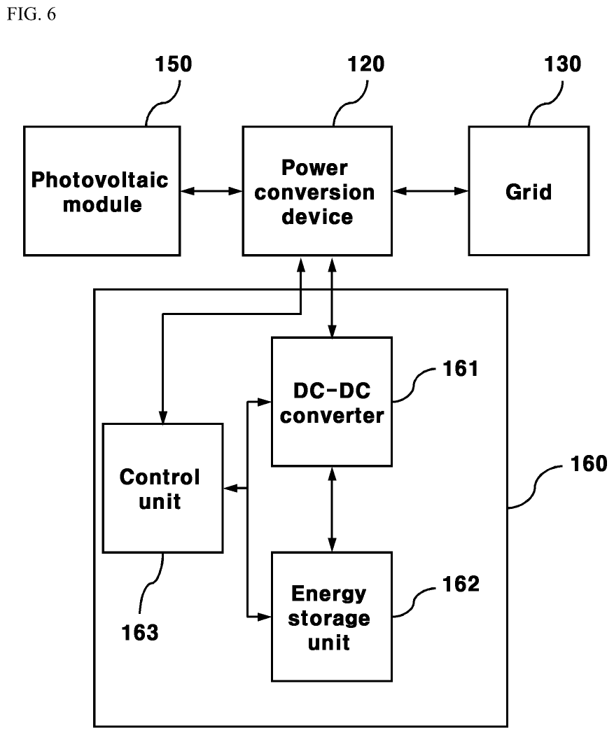

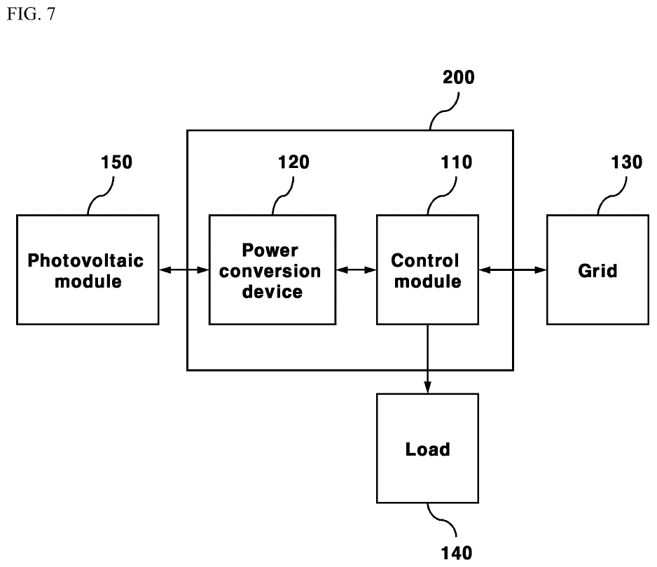

FIG. 1 is a block diagram showing a connection relationship with other components of a control module according to an embodiment of the present invention; FIG. 2 is a block diagram of a control module according to an embodiment of the present invention; FIG. 3 and FIG. 4 are block diagrams of a control module according to an implementation example of the present invention; FIG. 5 is a block diagram showing a connection relationship with other components of a battery module according to an embodiment of the present invention; FIG. 6 is a block diagram of a battery module according to an embodiment of the present invention; and FIG. 7 is a block diagram of a photovoltaic system according to an embodiment of the present invention.

A control module 110 according to one embodiment of the present invention comprises a switching unit 111 and a control unit 112. The control module 110 according to one embodiment of the present invention is connected to a power conversion device 120, a grid 130, and a load 140, and is a module that connects the power conversion device 120 and the load 140 or connects the grid 130 power to the load 140, and may include a backup module or a communication module, or may be disposed in a backup module or a communication module. Here, the backup module may include a backup box, and may include a junction box or an ATS box, a distribution board, a distribution box, and the like.

The switching unit 111 selectively connects the output of the power conversion device 120 or the power of the grid 130 to the load 140. The power required for the load 140 can be supplied to the power of the grid 130, or the power according to the output of the power conversion device 120 that converts the output of the photovoltaic module 150 as a backup for the power of the grid 130 can be supplied to the load 140. At this time, the switching unit 111 can selectively connect the power conversion device 120 or the grid 130 as a power supply source that supplies power to the load 140. In addition, power can be supplied through the power conversion device 120 from a battery module 160 being connected to and charged by the power conversion device 120. Here, the load 140 can be a device that uses power generated through solar power generation. If the solar system is installed in a home, the load 140 may be devices within the home.

The switching unit 111 may include an automatic transfer switch (ATS). The automatic transfer switch 113 is a device that automatically switches the main power supply to a backup power supply when an abnormality such as a power outage occurs. If the main power supply comes back on while the backup power supply is connected, the function of restoring the backup power supply to the normal power supply may be included. The switching unit 111 may include other types of switching elements such as a MOSFET or relay in addition to the automatic transfer switch.

The control unit 112 monitors the power conversion device 120 and controls the photovoltaic module 150 being connected to the power conversion device 120.

The power conversion device 120 is a device that converts the output of the photovoltaic module 150 into power suitable for the load 140 or the grid 130, and the power conversion device 120 may be a power converting system (PCS) or an inverter. The power conversion device 120 may be connected to a photovoltaic module 150 that performs solar power generation. Here, the photovoltaic module 150 may be a photovoltaic (PV) module. The photovoltaic module 150 may include one or more solar cells, and the solar cells have different maximum power points depending on the amount of sunlight, temperature, and the like. In order to operate the solar cells at the maximum power point, an optimizer or module-level power electronics (MLPE) that performs maximum power point tracking (MPPT) control on a module-by-module basis may be used. A power conversion device 120 being connected to a photovoltaic module 150 equipped with an MLPE 151 can receive voltage input through the MLPE 151.

The power conversion device 120 and the MLPE 151 of the photovoltaic module 150 can perform communication. The MLPE 151 can operate the photovoltaic module 150 by being connected to the communication with the power conversion device 120. The MLPE 151 can stop the operation of the photovoltaic module 150 when the communication with the power conversion device 120 is not connected or the communication is blocked. The power conversion device 120 and the MLPE 151 can perform communication using the PLC communication method. Power line communication (PLC) is a power line communication method that includes a signal for communication in a signal transmitted through a power line and transmits it. When the PLC communication method is used, communication can be performed simultaneously with power transmission using only the power line without a separate connection line for communication. The MLPE 151 and the power conversion device 120 can communicate using various communication methods such as a CAN communication other than a PLC communication.

The control unit 112 can monitor the power conversion device 120. The control unit 112 can monitor the grid 130, the MLPE 151 of the photovoltaic module 150, and the battery module 160 together with the power conversion device 120. That is, each component can be monitored in order to increase the energy efficiency of the entire photovoltaic system. The control unit 112 may include an energy management system (EMS).

The control unit 112 can charge the battery module 160 through the power conversion device 120 according to the amount of photovoltaic power generated by the photovoltaic module 150, connect the power conversion device 120 to the load 140 to transfer power stored in the battery module 160 to the load 140, or when the amount of photovoltaic power generated or the amount of charge in the battery module 160 is insufficient, connect the grid 130 to the load 140 to efficiently supply power to the load 140.

The control unit 112 can control the signal transmission of the power conversion device 120 to the photovoltaic module 150. The control unit 112 is not directly connected to the photovoltaic module 150, but is connected to the power conversion device 120, and the power conversion device 120 controls the signal transmission to the photovoltaic module 150, thereby controlling the photovoltaic module 150. The control unit 112 communicates with the power conversion device 120, and accordingly allows the power conversion device 120 and the photovoltaic module 150 to communicate, thereby enabling the power conversion device 120 to communicate with the photovoltaic module 150 through the power conversion device 120.

The control unit 112 communicates with the photovoltaic module 150 through the power conversion device 120 and can use this to control the operation of the photovoltaic module 150. In addition, the control unit 112 can monitor and control the battery module 160 being connected to the power conversion device 120.

As described previously, the photovoltaic module 150 operates when communication with the power conversion device 120 is connected, and can stop operating when communication with the power conversion device 120 is cut off. The photovoltaic module 150 can be connected as an array of multiple photovoltaic modules, and when one of the photovoltaic modules is stopped, the corresponding photovoltaic module can be bypassed.

The control unit 112 can transmit a control signal to the power conversion device 120 to block signal transmission to the photovoltaic module 150 when a rapid shut down (RSD) situation occurs. If the photovoltaic module 150 operates depending on whether it communicates with the power conversion device 120, this can be used to block communication between the power conversion device 120 and the photovoltaic module 150 when an abnormal situation occurs, thereby stopping the operation of the photovoltaic module 150.

The control unit 112 monitors the power conversion device 120, and can monitor the output of the photovoltaic module 150 being inputted to the power conversion device 120. The input voltage being inputted to the power conversion device 120 is monitored, and if the range of the input voltage is an abnormal range, the input voltage can be cut off. If an abnormality such as a fire occurs in the photovoltaic module 150, the voltage level of the input voltage is lowered, and therefore, if an input voltage in an abnormal range is inputted, the input voltage can be quickly cut off. If a fire occurs, workers such as firefighters can approach the solar power generation panel, and since the residual voltage is high, there may be a risk of electric shock. In this situation, the control unit 112 can perform a rapid shut down (RSD) function. Rapid shut down (RSD) is a function for safety, and is a function that can quickly lower the voltage if an abnormality occurs. During normal operation, RSD operates in standby or sleep mode, and when an abnormality occurs, it operates in operating or wake-up mode to quickly lower the voltage.

The control unit 112 can transmit a control signal to the power conversion device 120 to block signal transmission to the photovoltaic module 150 when a rapid shut down (RSD) situation occurs. The power conversion device 120 blocks signal transmission to the photovoltaic module 150 according to the control signal, and the photovoltaic module 150 confirms that signal reception from the power conversion device 120 is blocked and stops operation, thereby quickly blocking the operation of the photovoltaic module 150 when an RSD situation occurs.

The control unit 112 monitors and controls the status of the photovoltaic module 150 and battery module 160 connected to the power conversion device 120 through communication with the power conversion device 120, and when an abnormality such as an RSD situation occurs, the entire system can be protected by quickly blocking the operation of the photovoltaic module 150 through communication with the power conversion device 120.

The control unit 112 communicates with the power conversion device 120 using a first communication method, and the power conversion device 120 can communicate with the photovoltaic module 150 using a second communication method. Here, the first communication method and the second communication method may be different from each other. For example, the first communication method may include a CAN communication method or an RS-485 communication method, and the second communication method may include a PLC communication method. Or, the second communication method may include a CAN communication method or an RS-485 communication method, and the first communication method may include a PLC communication method. The communication method between the control unit 112 of the control module 110 and the power conversion device 120 and the communication method between the power conversion device 120 and the photovoltaic module 150 may be different from each other, thereby increasing compatibility. That is, the control unit 112 can communicate with the photovoltaic module 150 through the power conversion device 120 without directly communicating with the photovoltaic module 150, so that the photovoltaic module 150 can be controlled only by communication with the power conversion device 120, regardless of the communication method between the power conversion device 120 and the photovoltaic module 150. It is natural that the first communication method and the second communication method can be the same.

The communication signal according to the first communication method can be converted into a communication signal according to the second communication method by the signal conversion unit included in the power conversion device 120. When the first communication method and the second communication method are different from each other, it is difficult for the control unit 112 and the photovoltaic module 150 to perform communication, so it is necessary to convert the signal according to the first communication method into a signal according to the second communication method, or to convert the signal according to the second communication method into a signal according to the first communication method. Each power conversion device 120 that performs communication includes a signal conversion unit, and the signal can be converted into a signal having a different communication method by the signal conversion unit. The signal can be converted by reconstructing the signal according to the first communication method according to the second communication method. Here, the signal conversion unit can be a micro controller unit (MCU) of the power conversion device 120 and can include a pulse generator for PLC communication.

The control unit 112 can be connected to a plurality of power conversion devices 120. The power conversion device 120 can be an inverter, and a plurality of inverters can be connected, and a plurality of photovoltaic module arrays and a plurality of batteries can be connected to one inverter. The control unit 112 can control a plurality of power conversion devices 120 and each component connected thereto. Since the control unit 112 is located in the control module 110 rather than the power conversion device 120, even if the number of power conversion devices 120 increases, the entire system can be controlled with a single control module 110.

As described previously, not only the control module 110 controls the photovoltaic module 150, but also the battery module 160 can control the photovoltaic module 150. As shown in FIGS. 5 and 6, the battery module 160 according to the embodiment of the present invention may comprise a power conversion device 120, a DC-DC converter 161, an energy storage unit 162, and a control unit 163.

The DC-DC converter 161 converts the output of the power conversion device 120. The DC-DC converter 161 converts the first voltage being outputted from the power conversion device 120 into a second voltage suitable for charging the energy storage unit 162. The energy storage unit 162 is connected to the DC-DC converter 161 and is charged or discharged. The energy storage unit 162 may include a plurality of battery cells. The control unit 163 monitors the power conversion device 120 and controls the photovoltaic module 150 being connected to the power conversion device 120. A detailed description of the control unit 163 that controls the photovoltaic module 150 corresponds to the detailed description of the control unit 112 of the control module 110 described previously, and thus, any overlapping description will be omitted below.

The control unit 163 can monitor and control the MLPE 151 of the photovoltaic module 150, the power conversion device 120 which is an inverter, the DC-DC converter 161, and the energy storage unit 162. The control unit 163 can control the signal transmission of the power conversion device 120 to the photovoltaic module 150, and when a rapid shut down (RSD) situation occurs, can transmit a control signal to the power conversion device 120 to block the signal transmission to the photovoltaic module 150.

The control unit 163 may include an energy management system EMS, and the control unit 163 communicates with the power conversion device 120 using a first communication method, and the first communication method may be different from a second communication method, which is a communication method between the power conversion device 120 and the photovoltaic module 150. In addition, a communication signal according to the first communication method may be converted into a communication signal according to the second communication method in a signal conversion unit included in the power conversion device 120. Here, the first communication method may include a CAN communication method, and the second communication method may include a PLC communication method.

A photovoltaic system 200 according to one embodiment of the present invention may be configured with a power conversion device 120 and a control module 110, as shown in FIG. 7. The power conversion device 120 may receive the output of the photovoltaic module 150 and perform a first communication with the photovoltaic module 150, and the control module 110 may selectively connect the output of the power conversion device 120 or the grid 130 power to the load 140. Here, the control module 110 may control the photovoltaic module 150 through a second communication with the power conversion device 120.

Since the control unit 163 controlling the photovoltaic module 150 is located in the battery module 160, communication can be achieved only by communication between DC signals without conversion between DC and AC signals in the power conversion device 120. Therefore, faster and more accurate communication can be achieved compared to when the control unit 112 of the control module 110 is used.

A detailed description of each component of the photovoltaic system 200 of FIG. 7 corresponds to the detailed description of the control module 110 and the photovoltaic system of FIGS. 1 to 4, and thus, any duplicate description will be omitted.

The control module 110 includes a switching unit 111 that selectively connects the output of the power conversion device 120 or the grid 130 power to a load, and a control unit 112 that monitors the power conversion device 120, and the control unit 112 can control a photovoltaic module being connected to the power conversion device. The control unit 112 can control signal transmission of the power conversion device 120 to the photovoltaic module 150, and when a rapid shut down (RSD) situation occurs, can transmit a control signal to the power conversion device 120 to block signal transmission to the photovoltaic module 150. Here, the control unit can include an energy management system (EMS) 114. The control unit 112 communicates with the power conversion device 120 using a first communication method; and the first communication method may be different from a second communication method, which is a communication method between the power conversion device 120 and the photovoltaic module 150. In addition, a communication signal according to the first communication method may be converted into a communication signal according to the second communication method by a signal conversion unit included in the power conversion device 120. Here, the first communication method may include a CAN communication method, and the second communication method may include a PLC communication method.

The control unit 112 can control multiple inverters, the switching unit 111 can include an automatic transfer switch (ATS), and the control unit 112 can monitor a battery module 160 being connected to the power conversion device 120.

The features, structures, effects, and the like described in the embodiments above are included in at least one embodiment and are not necessarily limited to only one embodiment. Furthermore, the features, structures, effects, and the like illustrated in each embodiment can be combined or modified and implemented in other embodiments by a person with ordinary knowledge in the field to which the embodiments belong. Therefore, contents related to such combinations and modifications should be interpreted as being included in the scope of the embodiments. Those skilled in the art related to the present embodiment will understand that the above-described description can be implemented in a modified form without departing from the essential characteristics thereof. Therefore, the disclosed methods should be considered from an illustrative rather than a restrictive perspective. The scope of the present invention is indicated by the claims, not the above description, and all differences within the scope equivalent thereto should be interpreted as being included in the present invention.

1-10. (canceled)

11. A control module comprising:
a switching unit selectively connecting an output of a power conversion device or a grid power source to a load; and
a control unit configured to monitor the power conversion device,
wherein the control unit controls a photovoltaic module connected to the power conversion device.

12. The control module according to claim 11,
wherein the control unit controls signal transmission from the power conversion device to the photovoltaic module.

13. The control module according to claim 11,
wherein the control unit transmits a control signal to the power conversion device to block signal transmission to the photovoltaic module when a rapid shut down (RSD) situation occurs.

14. The control module according to claim 11,
wherein the control unit comprises an energy management system (EMS).

15. The control module according to claim 11,
wherein the control unit communicates with the power conversion device using a first communication method, and
wherein the first communication method is different from a second communication method which is a communication method between the power conversion device and the photovoltaic module.

16. The control module according to claim 15,
wherein a communication signal according to the first communication method is converted into a communication signal according to the second communication method in a signal conversion unit comprised in the power conversion device.

17. The control module according to claim 15,
wherein the first communication method comprises a CAN communication method, and
wherein the second communication method comprises a PLC communication method.

18. The control module according to claim 11,
wherein the control unit controls a plurality of inverters.

19. The control module according to claim 11,
wherein the switching unit comprises an automatic transfer switch (ATS).

20. The control module according to claim 11,
wherein the control unit monitors a battery module connected to the power conversion device.

21. A battery module comprising:
a DC-DC converter configured to convert output of a power conversion device;
an energy storage unit connected to the DC-DC converter and configured to be charged or discharged; and
a control unit configured to monitor the power conversion device,
wherein the control unit controls a photovoltaic module connected to the power conversion device.

22. The battery module according to claim 21,
wherein the control unit controls signal transmission from the power conversion device to the photovoltaic module.

23. The battery module according to claim 21,
wherein the control unit transmits a control signal to the power conversion device to block signal transmission to the photovoltaic module when a rapid shut down (RSD) situation occurs.

24. The battery module according to claim 21,
wherein the control unit comprises an energy management system (EMS).

25. The battery module according to claim 21,
wherein the control unit communicates with the power conversion device using a first communication method, and
wherein the first communication method is different from a second communication method which is a communication method between the power conversion device and the photovoltaic module.

26. The battery module according to claim 25,
wherein a communication signal according to the first communication method is converted into a communication signal according to the second communication method in a signal conversion unit comprised in the power conversion device.

27. The battery module according to claim 25,
wherein the first communication method comprises a CAN communication method, and
wherein the second communication method comprises a PLC communication method.

28. The battery module according to claim 21,
wherein the control unit controls a plurality of inverters.

29. The battery module according to claim 21,
wherein the switching unit comprises an automatic transfer switch (ATS).

30. A photovoltaic system comprising:
a power conversion device configured to receive an output of a photovoltaic module and perform a first communication with the photovoltaic module; and
a control module configured to selectively connect the output of the power conversion device or a grid power supply to a load,
wherein the control module controls the photovoltaic module through a second communication with the power conversion device.
